(19) United States
(12) Patent Application Publication
(10) Pub. No.: US 2012/0159064 A1
(43) Pub. Date: Jun. 21, 2012

(54) HARD DISK DRIVE

(75) Inventors: KANG WU, Shenzhen City (CN); BO TIAN, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/036,048

(22) Filed: Feb. 28, 2011

(30) Foreign Application Priority Data
Dec. 20, 2010 (CN) 201010596748.4

(51) Int. Cl. G06F 12/00

(52) U.S. Cl. 711/112; 711/E12.001

(57) ABSTRACT

A hard disk drive includes an interface, a data process system, a memory unit, a microprocessor, and an indicator module. The interface is connected to a computer for data transmission. The data process system is connected between the interface and the memory unit for reading data to or writing data from the memory unit. The microprocessor is connected with the interface for determining the status of the hard disk drive and controls the operation modes of the indicator module for illustrating whether the hard disk drive is exchanging data with the computer or whether the hard disk drive is in a fault condition.

### Technical Field

The disclosure generally relates to a hard disk drive for a computer.

### Description of Related Art

A hard disk drive is an important data storage apparatus used in a server, data center or computer system. Many computer systems are equipped with more than two hard disk drives, so that indicators are provided for showing the status of each hard disk drive. Generally, plastic light pipes are used to guide light from the indicators to a position visible to users. However, plastic light pipes will increase the cost of the system. Also, because lights from different plastic light pipes will affect each other, the design of the plastic light pipes is complicated and time-consuming.

Therefore, an improved hard disk drive is desired to overcome the above described shortcomings

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a schematic functional diagram illustrating a hard disk drive in accordance with a first embodiment.

FIG. 2 shows a position of an indicator module in the hard disk drive of FIG. 1.

### DETAILED DESCRIPTION

Embodiments of a hard disk drive will now be described in detail below and with reference to the drawings.

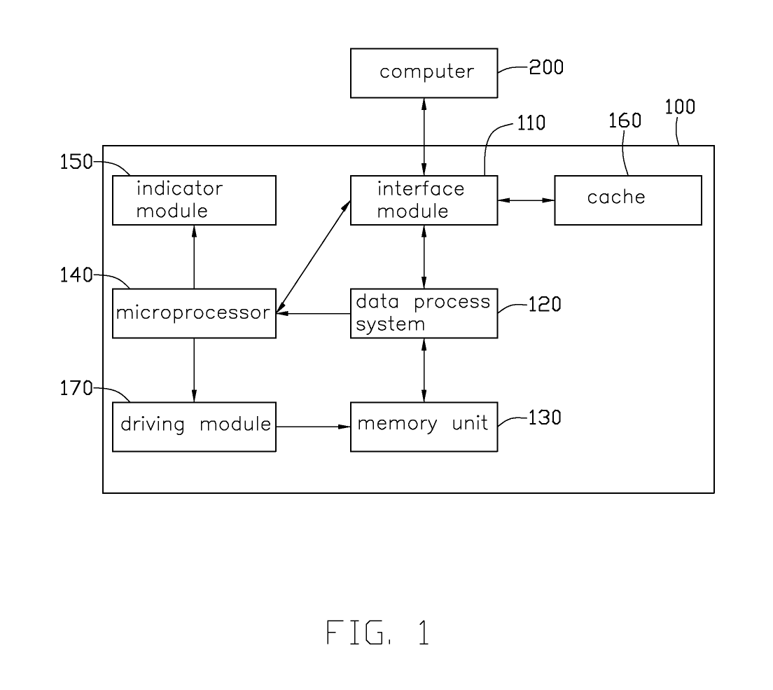

Referring to FIG. 1, a hard disk drive 100 in accordance with a first embodiment includes an interface 110, a data process system 120, a memory unit 130, a microprocessor 140, and an indicator module 150.

The interface 110 is electrically connected to a computer 200 for data transmission. The interface 110 may be a parallel ATA interface (PATA), a small computer system interface (SCSI) or a serial ATA interface (SATA). The interface 110 detects status of the hard disk drive 100, for example, active or inactive or fault states of the hard disk drive 100, and then transmits the status messages to the microprocessor 140.

The data process system 120 is connected between the interface 110 and the memory unit 130. The data process system 120 receives instructions from the computer 200 and then generates a control signal to read data from or/and write data to the memory unit 130. And, the data process system 120 can also detect the status of the hard disk drive 100 and transmit the status to the microprocessor 140.

The memory unit 130 is connected to the interface 110 through the data process system 120 for storing information and instructions used by the data process system 120. When data needs to be transmitted from the hard disk drive 100 to the computer 200, the data process system 120 reads data from the memory unit 130 and transmits it to the computer 200 through the interface 110. When data needs to be transmitted from the computer 200 to the hard disk drive 100, the data process system 120 receives the data from the interface 110 and stores it in the memory unit 130.

The microprocessor 140 is electrically connected with the interface 110 for determining the status of the hard disk drive 100, and then controls operation modes of the indicator module 150 according to the status of the hard disk drive 100. In alternative embodiments, the microprocessor 140 is electrically connected with the interface module 150 through the data process system 120 and is able to receive the status of the hard disk drive 100 from the data process system 120 and can also communicate with the interface through the data process system 120.

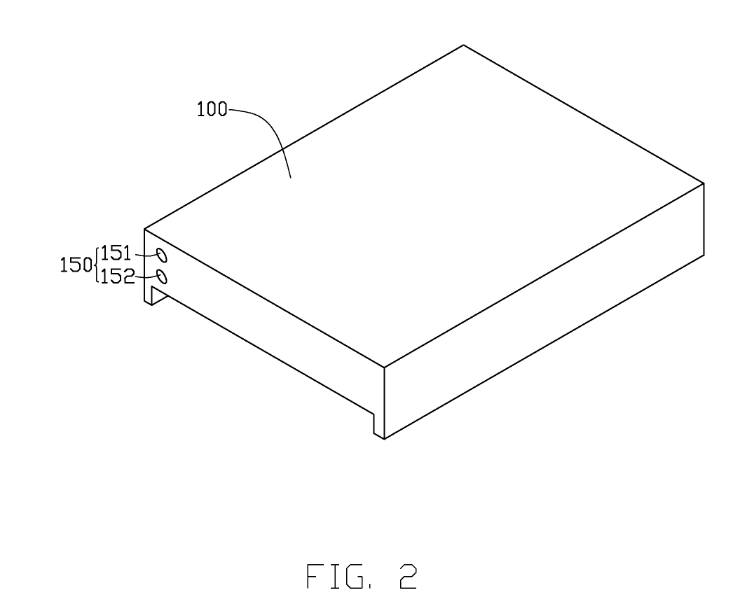

The indicator module 150 is electrically connected with the microprocessor 140 for indicating the status of the hard disk drive 100. Referring also to FIG. 2, the indicator module 150 includes a first indicator 151 and a second indicator 152. The first indicator 151 and second indicator 152 can be light emitting diode (LED) indicators and formed at the front side of the hard disk drive 100 visible to users. In an alternative embodiment, the first indicator 151 and the second indicator 152 can be formed at the back side of the hard disk drive 100. The first indicator 151 is to determine whether the hard disk drive 100 is exchanging data with the computer 200. The first indicator 151 will light up when the hard disk drive 100 is in active state and exchanging data with the computer 200; and, the first indicator 151 will be in a turned off or inactive state when the hard disk drive 100 is not exchanging data with the computer 200. The second indicator 152 is to determine whether the hard disk drive 100 is in fault state. The lighting of the second indicator 152 means that the hard disk drive 100 is in fault state and needs to be repaired.

Because the first indicator 151 and the second indicator 152 are formed at the front side or back side of the hard disk drive 100 visible to the users, users can determine the active state or fault state of the hard disk drive 100 by observing the operation modes of the first indicator 151 and the second indicator 152. Therefore, there is no need for any light guide pipe for guiding light to a position visible to the users. And thus without the light guide pipe, the cost of the computer system will be decreased. Because the indicator module 150 is connected with the microprocessor 140 formed inside the hard disk drive 100, the status of the hard disk drive 100 can be detected by the operation modes of the indicator module 150.

In alternative embodiments, the hard disk drive 100 can further include a cache 160 (see FIG. 1), which is connected to the interface 110 for temporarily storage of information and instructions that need to be exchanged between the hard disk drive 100 and the computer 200. The cache 160 can increase the speed of transmission between the hard disk drive 100 and the computer 200.

In alternative embodiments, the hard disk drive 100 can further include a driving module 170. The driving module 170 is connected between the microprocessor 140 and the memory unit 130. The memory unit 130 generally includes an actuator arm extending over the disk for reading or writing data and the driving module 170 controls the movement of the actuator arm of the memory unit 130.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A hard disk drive comprising:
an interface being configured for connecting to a computer for data transmission;
a memory unit being connected to the interface;
a data process system being connected between the interface and the memory unit for executing instructions of the computer;
an indicator module for illustrating states of the hard disk drive ; and
a microprocessor connected with the interface for determining states of the hard disk drive and controlling operation modes of the indicator module according to the states of the hard disk driver.

2. The hard disk drive of claim 1, wherein the indicator module comprises a first indicator for determining whether the hard disk drive is exchanging data with the computer.

3. The hard disk drive of claim 2, wherein the first indicator is in a lit state when the hard disk drive is exchanging data with the computer; and the first indicator is in an unlit state when the hard disk drive is not exchanging data with the computer.

4. The hard disk drive of claim 2, wherein the first indicator is a light emitting diode indicator.

5. The hard disk drive of claim 2, wherein the first indicator is formed at the front side or back side of the hard disk driver.

6. The hard disk drive of claim 2, wherein the indicator module further comprises a second indicator for determining whether the hard disk drive is in a fault condition.

7. The hard disk drive of claim 6, wherein the second indicator lights up when the hard disk drive is in fault condition.

8. The hard disk drive of claim 6, wherein the second indicator is formed at the front side or the back side of the hard disk drive where is visible to users.

9. The hard disk drive of claim 1, wherein the microprocessor is electrically connected with the data process system for determining states of the hard disk driver.

10. The hard disk drive of claim 1, further comprising a cache connected to the interface for temporarily storing information and instructions exchanged between the hard disk drive and the computer.

11. The hard disk drive of claim 1, further comprising a driving module connected between the microprocessor and the memory unit for controlling a movement of an actuator arm of the memory unit.
